(19) United States
(12) Patent Application Publication
(10) Pub. No.: US 2019/0317290 A1
(43) Pub. Date: Oct. 17, 2019

(54) SELECTIVELY-ILLUMINATED CABLE CLADDING

(71) Applicant: Microsoft Technology Licensing, LLC, Redmond, WA (US)

(72) Inventors: Anne Marie CARTER, Soap Lake, WA (US); Kevin Collin LUTZ, Ephrata, WA (US); Winston Allen SAUNDERS, Seattle, WA (US)

(21) Appl. No.: 15/954,811

(22) Filed: Apr. 17, 2018

(51) Int. Cl. G02B 6/44

(52) U.S. Cl. CPC G02B 6/447

(57) ABSTRACT

A system includes a cable, a first material covering at least a portion of the cable, the first material having a first index of refraction, and a second material covering at least a portion of the first material, where the second material is at least partially transparent and has a second index of refraction greater than the first index of refraction.

### BACKGROUND

Modern computing systems typically include several computing, storage and networking components. These components communicate with one another via communication cables which carry, for example, electrical or optical signals between the components. Increasing the number of components in a system leads to corresponding increases in the number of required communication cables.

It may be necessary to trace the path of a particular communication cable during maintenance and/or repair of a computing system. Tracing the path of a particular cable amongst dozens or hundreds of adjacent and intertwined cables, particularly in a data center environment, is time-consuming and inefficient. Some systems attempt to address this issue by providing a light source at each end of a cable. These systems facilitate identification of cable ends, but do not address the identification of other portions of the cable. Such systems would not improve a technician's ability to, for example, find a cable among a large bundle of cables laying in a data center cable tray.

Systems are desired to efficiently assist in the tracing of communication cables.

### BRIEF DESCRIPTION OF THE DRAWINGS

FIG. 1 illustrates communication cables within a data center.

FIG. 2A is a representative view of a cable connecting two hardware components according to some embodiments.

FIG. 2B is a representative view of a cable connecting two hardware components and selectively illuminated according to some embodiments.

FIG. 3A is a widthwise cross-sectional view of an apparatus according to some embodiments.

FIG. 3B is a lengthwise cross-sectional view of an apparatus according to some embodiments.

FIG. 3C is a lengthwise cross-sectional view illustrating operation of an apparatus according to some embodiments.

FIG. 4 is a perspective view of an apparatus including a light injection apparatus coupled thereto according to some embodiments.

FIG. 5 is a lengthwise cross-sectional view of an apparatus including a light injection apparatus coupled thereto according to some embodiments.

FIG. 6 is a widthwise cross-sectional view of an apparatus including a light injection apparatus coupled thereto according to some embodiments.

FIG. 7A is a widthwise cross-sectional view of an apparatus according to some embodiments.

FIG. 7B is a lengthwise cross-sectional view of an apparatus according to some embodiments.

FIG. 8A is a widthwise cross-sectional view of an apparatus according to some embodiments.

FIG. 8B is a lengthwise cross-sectional view of an apparatus according to some embodiments.

FIG. 9 is a flow diagram of a process to manufacture and utilize an apparatus according to some embodiments.

### DETAILED DESCRIPTION

The following description is provided to enable any person in the art to make and use the described embodiments. Various modifications, however, will remain readily-apparent to those in the art.

Generally, some embodiments provide a system to selectively illuminate a communication cable. A cable according to some embodiments includes a first cladding covering at least a portion of the cable and a second cladding covering at least a portion of the first cladding. The first cladding is composed of a first material having a first index of refraction, and the second cladding is composed of a second material having a second index of refraction greater than the first index of refraction. This arrangement allows selective illumination of the cable according to some embodiments.

For example, upon injecting light into the second cladding at an appropriate angle, the light travels through the second cladding and illuminates the second cladding. The second cladding may include imperfections, reflective material, phosphorescent material, or other material which facilitates perception of the light from outside the second cladding. The light may be selectively injected into the second cladding of a selected cable using a light injection apparatus as will be described below. Accordingly, embodiments may provide an efficient system to “light up” a selected cable so that the cable may be efficiently traced and, if needed, serviced. Moreover, as will also be described below, a cable may be selectively illuminated without disconnecting the cable from the components it connects.

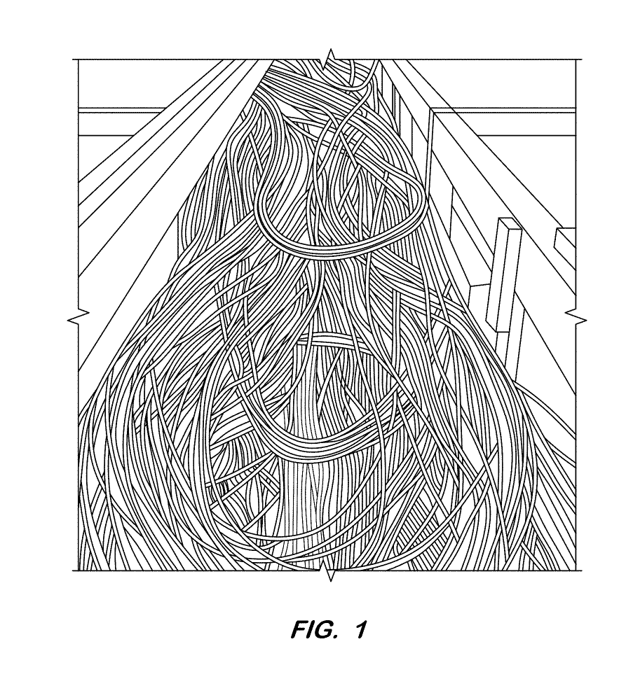

FIG. 1 is an example of a group of communication cables within a data center. Each end of each cable may be coupled to a hardware component. Examples of such components include switches, routers, patch panels, servers, and backplanes. Embodiments are not limited to any particular types of hardware components. Selective cable illumination according to some embodiments does not require a cable to be connected, at any cable end, to a hardware component. Moreover, embodiments are not limited to any particular type of communication cable, or to communication cables generally. Embodiments may therefore be implemented in conjunction with any type of electrical data cables, optical data cables, wires, hoses, tubes, ropes, cords, pipes, or any other suitable structure.

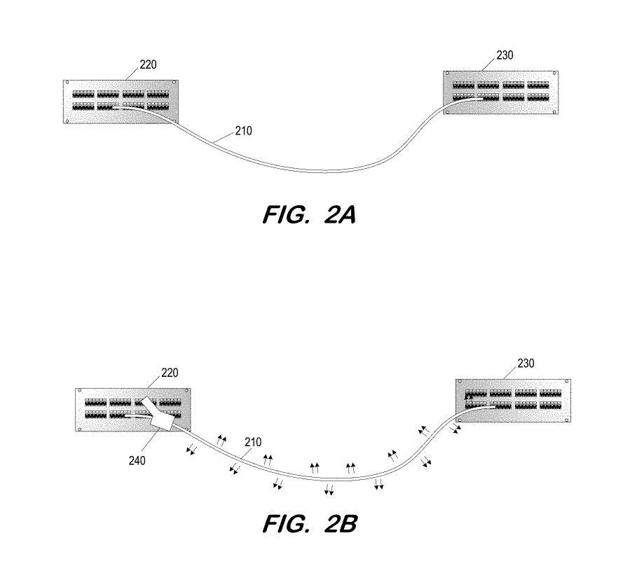

FIG. 2A illustrates cable 210 coupled to patch panels 220 and 230. Cable 210 may comprise an optical fiber cable or an Ethernet cable but, as described above, embodiments are not limited thereto. FIG. 2B illustrates illumination of cable 210 according to some embodiments. As shown, injection apparatus 240 is coupled to cable 210. Injection apparatus 240 operates to emit light which enters an outer cladding of cable 210 at an injection angle which causes at least partial internal reflection of the light within the outer cladding. In some embodiments, the injection angle results in total internal reflection of the injected light.

Injection of the light causes cable 210 to illuminate along at least a portion of its length as illustrated. In some embodiments, the outer cladding includes elements to disperse some of the internally-reflected light away from cable 210 (i.e., toward an observer). Examples of these elements include imperfections within the outer cladding and small synthetic beads. The outer cladding may include phosphorescent elements which glow in response to received light.

Accordingly, a technician may selectively illuminate cable 210 using injection apparatus 240. FIGS. 2A and 2B illustrate a single cable for clarity but many other cables may be connected between components 220 and 230 during the above-described operation. Illumination of cable 210 may therefore facilitate tracing of cable 210 amongst the many other cables. Moreover, as illustrated, cable 210 may be illuminated without requiring disconnection of cable 210 from components 220 or 230. Accordingly, embodiments may allow selective communication of an actively-communicating or otherwise fully-deployed cable.

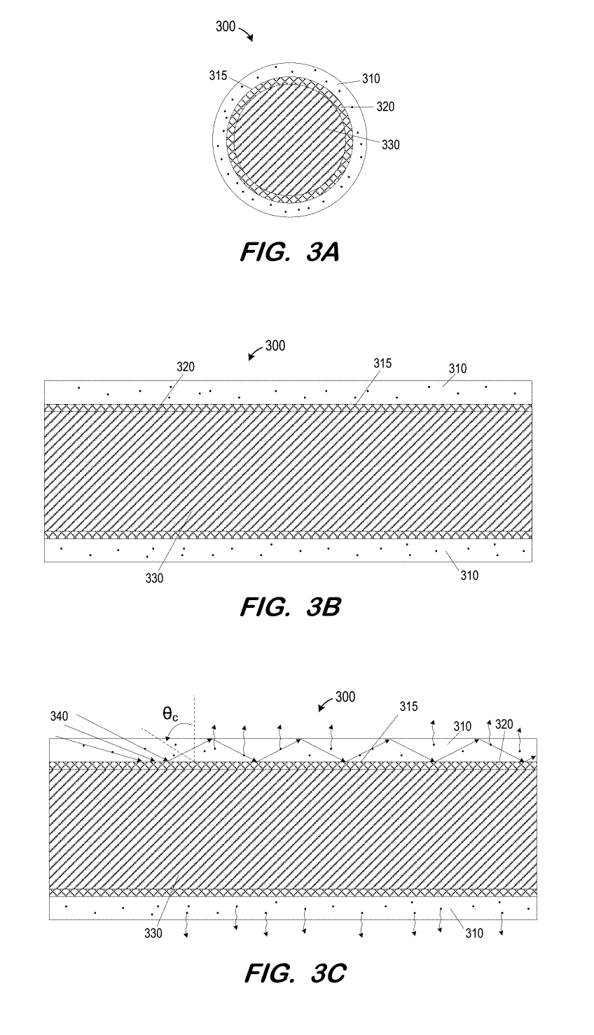

FIGS. 3A through 3C are cross-sectional views of an apparatus according to some embodiments. Cable 300 includes inner cable 330, cladding 320 surrounding inner cable 330, and cladding 310 surrounding cladding 320. Inner cable 330 may include any type of cable for performing any type of function. In a case that inner cable 330 is an optical fiber cable, inner cable 330 may consist of at least one core and corresponding cladding layer, all of which may be surrounded by a layer of acrylate polymer, polyimide or one or more other protective layers. Specific details of the construction of cable 330 are not illustrated as they will differ among the possible types/functions of cable 330 and are known to those in the art of those cable types/functions.

Cladding 320 is composed of a first material and cladding 310 is composed of a second material. The refractive index of the first material of cladding 320 is lower than the refractive index of the second material of cladding 310. According to some embodiments, cladding 320 and cladding 310 are composed of polymers, where the polymer of cladding 320 exhibits a lower index of refraction than the polymer of cladding 310. For example, cladding 320 may be composed of polyethylene, having an index of refraction of 1.53, and cladding 310 may be composed of polyferrocenylsilanes, having an index of refraction of 1.7.

By virtue of the foregoing arrangement, light entering cladding 310 within a certain range of entry angles will be totally reflected at interface 315 between cladding 310 and cladding 320. The range of entry angles may be determined using Snell's law, which calculates the critical angle as θ_{c}=sin⁻¹(n₃₂₀/n₃₁₀), as depicted in FIG. 3C. Using the indices of refraction of the above example, θ_{c}=64 degrees. Accordingly, the range of entry angles includes angles between 64 and 90 degrees from perpendicular to interface 315. FIG. 3C illustrates light beams 340, each of which intercepts interface 315 at an angle between 64 and 90 degrees from perpendicular and will therefore be totally internally reflected at interface 315. The critical angle at the interface of cladding 310 and air (nₐᵢᵣ=1) is sin⁻¹(nₐᵢᵣ/n₃₁₀)=36 degrees, therefore the light intercepting the cladding 310/air interface at an angle between 64 and 90 degrees from perpendicular will also experience total internal reflection at that interface.

Cladding 310 includes small elements embedded therein. These elements may scatter some of the internally-reflected light out from cladding 310 as shown in FIG. 3C, where it may be perceived by an observer. Examples of these elements include small (e.g., 1-2 mm thickness) plastic or glass beads. Cladding 310 may include any suitable elements to direct light out from cladding 310 toward an observer in response to light injected therein, including but not limited phosphorescent elements.

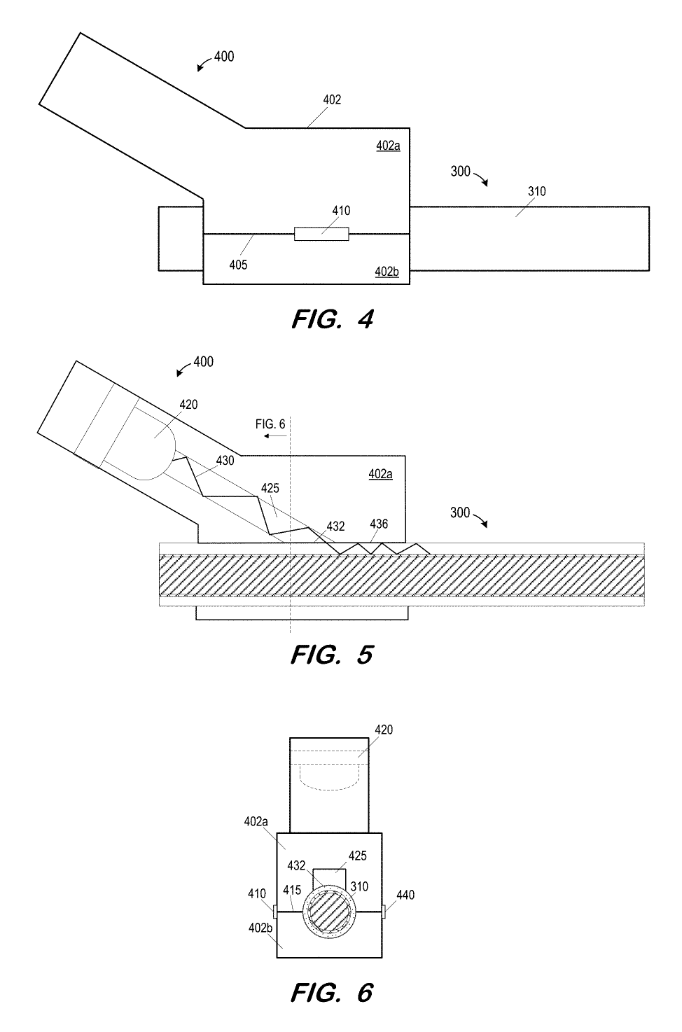

FIG. 4 illustrates light injection apparatus 400 coupled to cladding 310 according to some embodiments. Apparatus 400 is configured to detachably attach to cladding 310 and to introduce light into cladding 310 at an angle resulting in total internal reflection as described above. Therefore, cladding 310 may be illuminated by attaching apparatus 400 to cladding 310 and operating apparatus 400 to inject the light as described, thereby assisting the identification of a cable which is covered by cladding 310.

According to the illustrated implementation, to which embodiments are not limited, apparatus 400 includes housing 402 consisting of upper portion 402a and lower portion 402b. Latch 410 secures upper portion 402a to lower portion 402b, securing internal surfaces of apparatus 400 to cladding 310 and creating seam 405.

FIG. 5 is a length-wise cross-sectional view and FIG. 6 is width-wise cross-sectional view of apparatus 400 of FIG. 4. As shown, upper portion 402a of housing includes light source 420 (e.g., a light-emitting diode) and light pipe 425. Light source 420 emits light 430 into light pipe 425 at suitable angle to cause total internal reflection of light 430 at the interface between light pipe 425 and upper portion 402a. In some embodiments, light source 420 emits light at many angles, and the light which is emitted within a range of suitable angles (i.e., a range determined by the indices of refraction of light pipe 425 and upper portion 402a) is totally internally reflected at the interface between light pipe 425 and upper portion 402a

In this regard, upper portion 402a of housing 402 may comprise a material having a lower index of refraction than the material of which light pipe 425 is composed. In some embodiments, light pipe 425 exhibits a similar or identical index of refraction as cladding 310, and may be composed of the same material as cladding 310. Upper portion 402a of housing may be composed of the same material as cladding 320. In a case that the index of refraction of light pipe 425 is substantially similar to the index of refraction of cladding 310, light 430 may pass through interface 432 between light pipe 425 and cladding 310 with minimal reflection or refraction. As illustrated, and due to the lower index of refraction of upper portion 402a and the higher index of refraction of cladding 310, light 430 experiences total internal reflection at interface 436 between cladding 310 and upper portion 402a.

Hinge 440 may couple upper portion 402a to lower portion 402b. According to some embodiments, an operator “opens” apparatus 400 by rotating upper portion 402a and lower portion 402b away from one another, with hinge 440 being the pivot point for this rotation. Upper portion 402a and lower portion 402b are placed around cladding 310 as shown and latched together using latch 410.

In some embodiments, optical epoxy or grease may be applied to interface 432 prior to attachment of apparatus 400 to cladding 310. This application may improve optical continuity between light pipe 425 and cladding 310. Optical continuity may also benefit from precise machining of light pipe 425 and upper portion 420a to match the profile of cladding 310. Similarly, light pipe 425 and upper portion 420a may be configured to firmly mate with light source 420, to assist optical continuity between light source 420 and light pipe 425. Embodiments are not limited to the arrangement of FIGS. 4 through 6, and may implement any system for selectively delivering light into cladding 310 at a suitable angle.

Light source 420 may be controlled and powered by any suitable circuitry. In some embodiments, light source 420 is powered by a battery and activated by a switch in any suitable configuration. For example, the securing of latch 410 may engage the switch, while opening of latch 410 may disengage the switch.

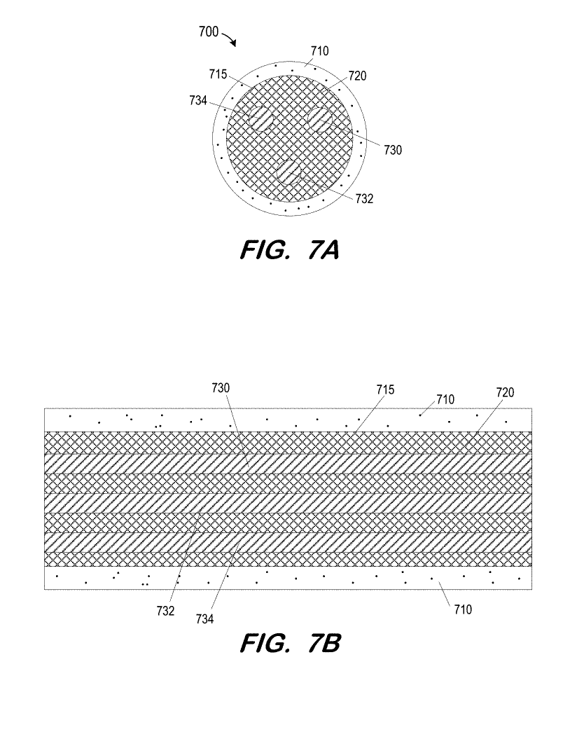

FIGS. 7A and 7B are cross-sectional views of an apparatus according to some embodiments. Cable 700 includes inner cables 730, 732 and 734, cladding 720 surrounding inner cables 730, 732 and 734, and cladding 710 surrounding cladding 720. In contrast to cable 300 of FIGS. 3A through 3C, cable 700 includes three inner cables, each of which may comprise any type of cable for performing any type of function. For example, each of inner cables 730, 732 and 734 may comprise an optical fiber cable consisting of at least one core and corresponding cladding layer. Moreover, inner cables 730, 732 and 734 are embedded within cladding 720, which therefore serves as a medium for physically separating and protecting inner cables 730, 732 and 734 as well as a medium providing the optical properties described above with respect to cladding 320.

In particular, cladding 720 is composed of a first material and cladding 710 is composed of a second material. The refractive index of the first material of cladding 720 is lower than the refractive index of the second material of cladding 710. Accordingly, light entering cladding 710 within a certain range of entry angles (e.g., using an apparatus such as apparatus 400) will be totally reflected at interface 715 between cladding 710 and cladding 720, and also at the interface between cladding 710 and ambient air. Cladding 710 includes embedded elements which scatter or otherwise transmit the light, or light generated therefrom, out toward an observer.

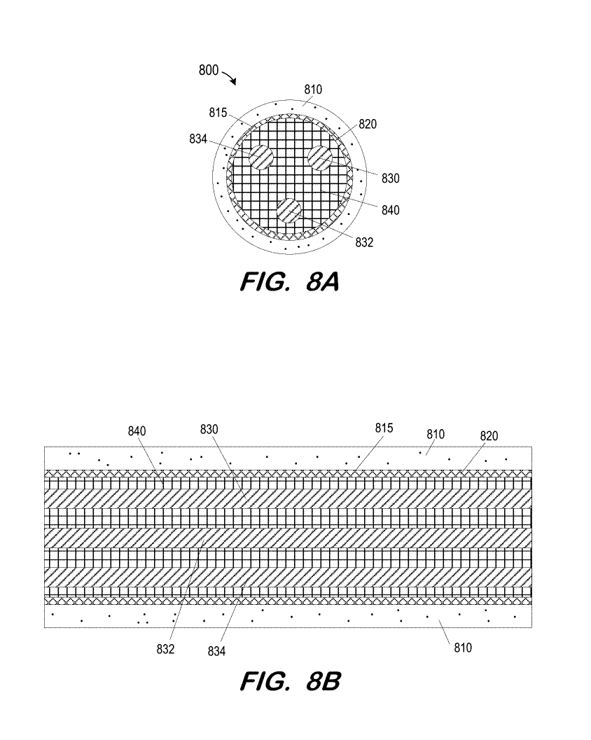

FIGS. 8A and 8B are cross-sectional views of an apparatus according to some embodiments. Cable 800 includes inner cables 830, 832 and 834, filler material 840 surrounding inner cables 830, 832 and 834, cladding 820 surrounding filler material 840, and cladding 810 surrounding cladding 820. Inner cables 830, 832 and 834 are embedded within filler material 840, which serves as a medium for physically separating and protecting inner cables 830, 832 and 834. Cladding 820 and cladding 810 may operate as described above with respect to cladding 320 and cladding 310 of cable 300.

For example, cladding 820 is composed of a first material having a first refractive index and cladding 810 is composed of a second material having a second refractive index which is greater than the first refractive index. Light entering cladding 810 within a certain range of entry angles (e.g., using an apparatus such as apparatus 400) will be totally reflected at interface 815 between cladding 810 and cladding 820, and also at the interface between cladding 810 and ambient air. Like claddings 310 and 710 described above, cladding 810 may include embedded elements which scatter or otherwise transmit the light, or light generated therefrom, out toward an observer.

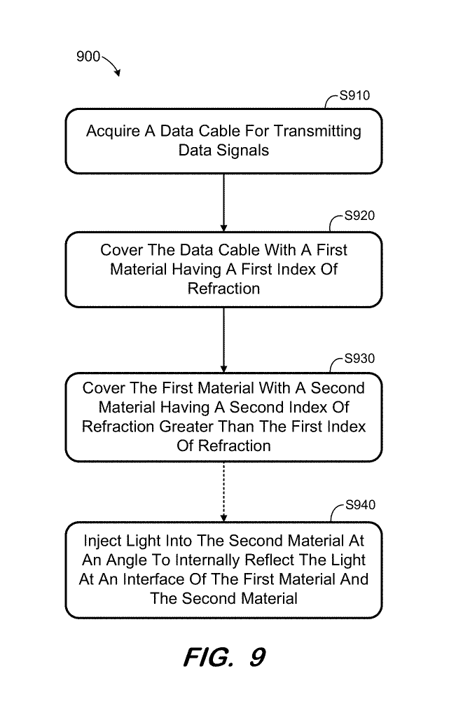

FIG. 9 is a flow diagram of process 900 according to some embodiments. Process 900 may be performed using any suitable manufacturing processes, including any combination of manufacturing hardware, software or manual means. Embodiments are not limited to the examples described below.

Initially, a data cable is acquired at S910. The data cable may comprise any type of cable for carrying one or more communication signals between electrical components. Next, at S920, at least a portion of the data cable is covered with a first material having a firs index of refraction. At S930, at least a portion of the second material is covered with a second material. The second material has a second index of refraction which is greater than the first index of refraction.

S940 may occur a good deal of time after S910, S920 and S930. S940 may occur during testing of the cable and/or after deployment of the cable in a computing system. Light is injected into the second material at S940. The light is injected at an angle which causes total internal reflection at an interface between the second material and the first material. The light may be injected at S940 using an apparatus such as apparatus 400 described above, but embodiments are not limited thereto.

Embodiments described herein are solely for the purpose of illustration. Those in the art will recognize other embodiments may be practiced with modifications and alterations to that described above.

1. An apparatus comprising:
a cable;
a first material continuously surrounding a circumference of the cable over a first length of the cable, the first material having a first index of refraction; and
a second material continuously surrounding a circumference of and in contact with the first material over the first length of the cable,
wherein the second material is at least partially transparent and has a second index of refraction greater than the first index of refraction, and
wherein the second material is capable of transmitting light along the first length of the cable, the transmitted light being internally reflected at a first interface between the second material and air.

2. An apparatus according to claim 1, wherein the second material comprises a plurality of opaque elements of a third material embedded in the second material.

3. An apparatus according to claim 1, wherein the first material comprises a first polymer, and wherein the second material comprises a second polymer.

4. An apparatus according to claim 3, wherein the first material comprises polyethylene, and wherein the second material comprises polyferrocenylsilanes.

5. An apparatus according to claim 1, wherein the cable comprises signal-carrying elements, a first connector connected to the signal-carrying elements at a first end of the cable, and a second connector connected to the signal-carrying elements at a second end of the cable.

6. An apparatus according to claim 1, further comprising:
a light injection apparatus comprising:
a light source,
an attachment portion to detachably attach to the second material and to optically couple the light source to the second material.

7. An apparatus according to claim 6, wherein the attachment portion optically couples the light source to the second material at an angle to cause at least partial internal reflection of light emitted from the light source at an interface between the second material and the first material.

8. An apparatus according to claim 6, wherein the attachment portion optically couples the light source to the second material at an angle less than or equal to arcsin(second index of refraction/first index of refraction) from perpendicular to the first material.

9. An apparatus according to claim 6, wherein an index of refraction of the attachment portion is substantially similar to the second index of refraction.

10. An apparatus according to claim 6, wherein the attachment portion comprises a light pipe portion, the light pipe portion composed of a third material having a third index of refraction substantially similar to the second index of refraction, and
wherein the light pipe portion is optically coupled to the second material.

11. An apparatus according to claim 10, wherein the attachment portion comprises a housing portion in contact with the light pipe portion, and
wherein an index of refraction of the housing portion is substantially similar to the first index of refraction.

12. An apparatus comprising:
a first cable cladding, the first cable cladding continuously surrounding a circumference of a cable over a first length of the cable and comprising a first material having a first index of refraction; and
a second cable cladding continuously surrounding a circumference of and in contact with the first cable cladding over the first length of the cable,
wherein the second cable cladding is at least partially transparent and comprises a second material having a second index of refraction greater than the first index of refraction, and
wherein the second cable cladding is capable of transmitting light along the first length of the cable, the transmitted light being internally reflected at a first interface between the second cable cladding and air.

13. An apparatus according to claim 12, wherein the second cable cladding comprises a plurality of opaque elements of a third material embedded in the second material.

14. An apparatus according to claim 12, wherein the first material comprises polyethylene, and wherein the second material comprises polyferrocenylsilanes.

15. An apparatus according to claim 12, further comprising:
a light injection apparatus comprising:
a light source,
an attachment portion to detachably attach to the second cable cladding and to optically couple the light source to the second cable cladding.

16. An apparatus according to claim 15, wherein the attachment portion optically couples the light source to the second cable cladding at an angle to cause at least partial internal reflection of light emitted from the light source at an interface between the second cable cladding and the first cable cladding.

17. An apparatus according to claim 15, wherein the attachment portion comprises a light pipe portion, the light pipe portion composed of a third material having a third index of refraction substantially similar to the second index of refraction, and
wherein the light pipe portion is optically coupled to the second cable cladding.

18. An apparatus according to claim 17, wherein the attachment portion comprises a housing portion in contact with the light pipe portion, and
wherein an index of refraction of the housing portion is substantially similar to the first index of refraction.

19. A method comprising:
acquiring a data cable for transmitting data signals;
covering a continuous circumference of the data cable over a first length of the data cable with a first material having a first index of refraction; and
covering and contacting a continuous circumference of the first material over the first length of the data cable with a partially-transparent second material having a second index of refraction greater than the first index of refraction,
wherein the second material is capable of transmitting light along the first length of the data cable, the transmitted light being internally reflected at a first interface between the second material and air.

20. A method according to claim 19, further comprising:
injecting light into the second material at an angle to internally reflect the light at an interface between the second material and the first material.
